(19) United States
(12) Patent Application Publication
(10) Pub. No.: US 2012/0323842 A1
(43) Pub. Date: Dec. 20, 2012

(54) SYSTEM AND METHODS FOR GROWTH, PEER-REVIEW, AND MAINTENANCE OF NETWORK COLLABORATIVE RESOURCES

(76) Inventors: Eugene M. Izhikevich, San Diego, CA (US); Leo Trottier, La Jolla, CA (US); Tobias Denninger, Karlsbad (DE)

(21) Appl. No.: 13/472,378

(22) Filed: May 15, 2012

Related U.S. Application Data
(60) Provisional application No. 61/486,715, filed on May 16, 2011.

(51) Int. Cl. G06F 17/30; G06F 15/16

(52) U.S. Cl. 707/608; 707/783; 707/E17.008

(57) ABSTRACT

System and methods for managing collaborative content resources, such as blogs, collaborative portals, and encyclopedias. In one embodiment, the collaborative resources comprise so-called “wikis” managed within an encyclopedia environment comprising a group of curators. The curators sponsor, peer-review, and accept or reject articles written by experts. When an article is accepted, the senior author joins the group of curators. Each accepted article has a curator and a group of assistant curators. When a registered user modifies the article, the modification is not shown to the public until it is approved by the curator or at least one assistant curator of the article. Upon approval, the user joins the group of assistant curators of the article. Each user has a rank, which in one variant reflects the number of times the approval or rejection decision by the user coincided with the approval or rejection decision by the curator.

### PRIORITY

This application claims priority to U.S. Provisional Patent Application Ser. No. 61/486,715 filed May 16, 2011 of the same title, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to collaborative network-based resources, and more particularly in one exemplary aspect to web-based encyclopedias that can be edited by the public.

### DESCRIPTION OF RELATED ART

In Wikipedia—the well known free encyclopedia that anybody can edit (see wikipedia.org)—each article can be edited and modified by any user. The Wikipedia server keeps the history of the content of each article and makes it available to the viewers. This functionality is often referred to as “wiki”, and many online collaborative resources (e.g., Google Knol) also use it.

Wikipedia has millions of dynamic and up-to-date articles written by the community. Yet many experts criticize Wikipedia as an unreliable resource of information because, inter alia, (i) it is not clear who actually wrote each article; (ii) such articles cannot be cited in scientific literature; and (iii) experts are often discouraged to be part of Wikipedia because their edits are overridden.

The peer-reviewed open-access encyclopedia—Scholarpedia (see scholarpedia.org)—overcomes this drawback. An expert writes each article in Scholarpedia. Then, the article undergoes rigorous peer-review process by anonymous reviewers, and upon acceptance by the reviewers, the author becomes the article's curator. Any registered user can modify Scholarpedia article (as in Wikipedia), but modifications are not shown to the public (they are hidden in the revision list) until the article's curator approves them. Subsequent to Scholarpedia's introduction, Wikipedia implemented the same mechanism; i.e., flagged revisions.

While Scholarpedia succeeded in attracting world experts to become its authors and curators, its author-selectivity process does not allow the same exponential growth as that of Wikipedia. This stems largely from the fact that such selectivity severely limits the rate of growth; only a small group of hand-selected people can become authors under the Scholarpedia model due to the requirement of a “central editor” acting as a bottleneck in the process. Growth is desirable in this context because, inter cilia, (i) a larger pool of authors (and hence a larger knowledge base) can be accessed, and (ii) information can propagate faster, whether over the web or otherwise.

In general, any web-based collaborative encyclopedia should reconcile two mutually exclusive requirements: (a) It should be truly collaborative, encouraging everybody to participate, resulting in exponentially growing content, and (b) it should be selective, biasing toward experts, resulting in high quality scholarly content. Wikipedia is an extreme case of element (a), whereas Scholarpedia is an extreme case of element (b).

Accordingly, there is a salient need for a collaborative resource approach which reconciles the two foregoing requirements, and which permits a sufficiently rapid rate of growth or expansion. Ideally, such improved approach would also maintain a high level of content quality.

### SUMMARY OF THE INVENTION

The present invention satisfies the foregoing needs by, inter cilia, providing methods and apparatus for managing collaborative resources via a networked environment.

In a first aspect of the invention, a collaborative resource server-based method is disclosed. In one embodiment of the method, at least one existing user with a first privilege grant a second privilege to a new user.

In one variant of the method, the network comprises the Internet, and the second privilege comprises the at least one existing user sponsoring the new user to write an article on a given topic.

In another variant, the first privilege comprises a curator privilege, and the new user acquires the first privilege when his/her activity due to the second privilege being validated by at least one other user having the curator privilege.

In yet another variant, the method further comprises the new user acquiring the first privilege when his/her activity due to the second privilege being validated by at least one other user having the first privilege.

In still another variant, the method further comprises users seeking a new privilege providing one or more URLs to others of the users and requesting the others of the users to click on the URLs in order to validate the new privilege.

In a second aspect of the invention, a wiki web server architecture is disclosed. In one embodiment, the architecture comprises: a plurality of articles; a plurality of curators; and a plurality of assistants. Each article has a curator and one or more assistants associated therewith, and modifications to each article are identified as either approved or rejected by the relevant curator or one or more assistants.

In one variant, a user who makes a modification to an article that is approved is permitted to join the one or more assistants associated with that article.

In another variant, the curator can override an approval or rejection of the one or more assistants.

In yet another variant, each of the one or more assistants has a score associated therewith, the score being based at least in part on a number of times an action of the assistant coincides with an action (e.g., approval or rejection) of the curator.

In another variant, each of the one or more assistants must keep their score above a designated threshold to be eligible to perform subsequent approvals or rejections.

In another embodiment of the architecture, each article has a curator and one or more assistants associated therewith; and modifications to each article made by the one or more assistants are approved by the relevant curator by either (i) affirmative approval; or (ii) tacit approval.

In one variant, the tacit approval comprises expiration of a predetermined period of time without an affirmative approval (i).

In a third aspect of the invention, a method of determining the content of an on-line article is disclosed. In one embodiment, the method is performed using a first party and at least one second party, and comprises: obtaining a first review of the article from the at least one second party; obtaining a second review of the article from the first party; comparing the results of the first and second reviews; and assigning a score to the at least one second party based at least in part on the act of comparing.

In another embodiment, the method is performed using a first party and a plurality of second parties, and comprises: obtaining a first review of the article from a first of the second parties; obtaining a second review of the article from a second of the second parties, the second review having a result different than that of the first review; obtaining a third review of the article from the first party; comparing the results of the first and third and second and third reviews; and based on the comparing, selecting either the result of the first review or the result of the second review.

In one variant, the method further comprises: assigning a first score to the second party whose review was selected; and assigning a second score to the second party whose review was not selected.

In a fourth aspect of the invention, computer readable apparatus is disclosed. In one embodiment, the apparatus comprises a storage medium adapted to store one or more computer programs. The one or programs are configured to, when executed, implement a network-based distributed responsibility collaborative resource management system.

In a fifth aspect of the invention, a network-based architecture is disclosed. In one embodiment, the architecture comprises a plurality of users operating in a peer-to-peer fashion over an internet or intranet. In one variant, the users are given different privileges for reviewing and editing resources (e.g., scholarly articles).

In a sixth aspect of the invention, a distributed network-based resource management model is disclosed. In one embodiment, the model comprises a plurality of assistant users, and a plurality of senior users or curators, with no centralized editor or curator. The decentralization of curators (and associated assistants) allows for more rapid growth of the information base of the network, and propagation of information.

In a seventh aspect of the invention, a mobile wireless device is disclosed. In one embodiment, the device includes a processor, a wireless network interface in data communication with the processor, a user interface in data communication with the processor; and a computer readable storage apparatus having at least one computer disposed thereon and operative to run on the processor. In one embodiment, the at least one program is configured to, when executed: receive from at least one existing user with a curator privilege a grant of a second privilege to a user of the mobile device, the second privilege comprising the at least one existing user sponsoring the new user to write an article on a given topic; generate at least a portion of the article using the mobile device; transmit the at least portion of the article via the wireless interface; cause storage the transmitted at least portion of the article in a file on a network storage apparatus; and receive indication of validation of the article by at least one other user having the curator privilege. In one variant, the mobile device is a smartphone or tablet computer with a touch screen display and input device, and WLAN (e.g., Wi-Fi) capability. In another variant, the mobile device is a laptop computer with keyboard and WLAN capability. The at least one computer program is rendered as an application (“app”) operative to run on the device.

### BRIEF DESCRIPTION OF THE DRAWINGS

FIG. 1 is a logical flow diagram illustrating one embodiment of the generalized method of collaborative resource creation and management according to the invention.

FIG. 1A is a logical flow diagram illustrating one exemplary implementation of the generalized method of FIG. 1.

FIG. 2. is a logical flow chart illustrating the functionality of another exemplary embodiment of the invention.

FIG. 3 is a block diagram of one embodiment of a mobile wireless device configured to implement one or more of the curator-based schema of the invention.

### DETAILED DESCRIPTION OF THE INVENTION

### Overview

In one salient aspect, the present invention provides an improved collaborative resource creation and management scheme for use over, e.g., networks such as the Internet. The improved scheme advantageously reconciles and harmonizes the two mutually exclusive requirements described supra, and provides an automatic way to exponentially grow and maintain a resource such as an encyclopedia with high-quality content.

In one embodiment, the invention is implemented as a peer-reviewed open-access encyclopedia written by experts and maintained by a plurality of individuals or entities (i.e., “curators” and “assistant curators”). It extends and improves on the capabilities and functionality of Wikipedia—(the free encyclopedia that anyone can edit) and Scholarpedia (the invitation-only peer-reviewed encyclopedia written by scholars from all around the world).

Specifically, in one embodiment, articles are sponsored by existing curators, with no editorial oversight or centralized manager. The system therefore can grow organically and in a distributed fashion, rather than being bottlenecked by a limited number of centralized entities.

Moreover, in the exemplary embodiment, the selection of reviewers may be made by the authors themselves. This feature is somewhat counter-intuitive, in that goes against the common wisdom of having anonymous peer-review process initiated by independent editors.

In another embodiment, the approval of a revision made by assistant curators may be made by the relevant curator either explicitly (i.e., via an affirmative acknowledgement or communication) or implicitly (e.g., a waiting period to give the curator the ability to override their decision which when expired, indicates the curator's tacit approval).

Additionally, implementations of the invention may include a ranking system; e.g., computation of the rank or score of an assistant curator based on, e.g., the number of times that assistant's decision coincided with the relevant curator's decision.

Advantages of the invention include one or more of 1) motivating article creation (including potential for line of c.v., potential to collaborate with world expert, and comparatively little effort involved); 2) ensures the quality of new articles (sponsorship, use of unique, responsible senior expert, accountability of all involved, and anonymous rejection); and 3) ensures the quality of existing articles (community approval or veto, and alignment of non-expert behavior with expert behavior).

### DETAILED DESCRIPTION OF EXEMPLARY EMBODIMENTS

Exemplary embodiments of the various aspects of the invention are now described in detail. It will be appreciated that while these embodiments are described primarily in terms of an Internet-based network used and scholarly articles, the present invention is in no way so limited. For example, the invention could be practiced using other types of networks having a sufficient number of users associated therewith, and/or in other contexts.

As used herein, the term “application” refers generally to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the JavaTV™ environment.

As used herein, the terms “collaborative resource” and “collaborative work” refer without limitation to any representation (tangible or otherwise) of a work, such as a scholarly or other article, book, picture, graphic, etc. that has contribution from two or more persons.

As used herein, the terms “network” and “bearer network” refer generally to any type of telecommunications or data network including, without limitation, data networks (including MANs, WANs, LANs, WLANs, internees, and intranets), satellite networks, and terrestrial cable or fiber networks. Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols.

The term “wiki” refers without limitation to a web system where users can modify content and the server keeps the history of the content and can show it to users, allowing the users to revert to previous revisions. Typical examples of such wikis are Wikipedia and other collaborative resources based on mediawiki open source platform, Google Knol, and Google Docs.

### Generalized Method:

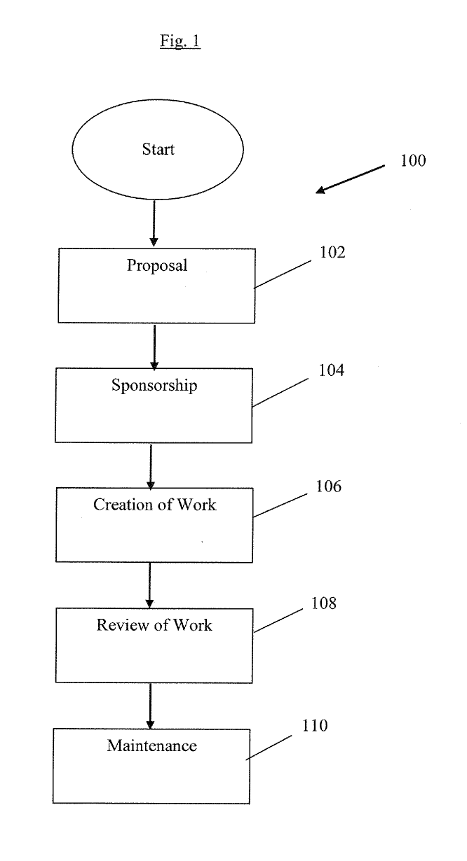

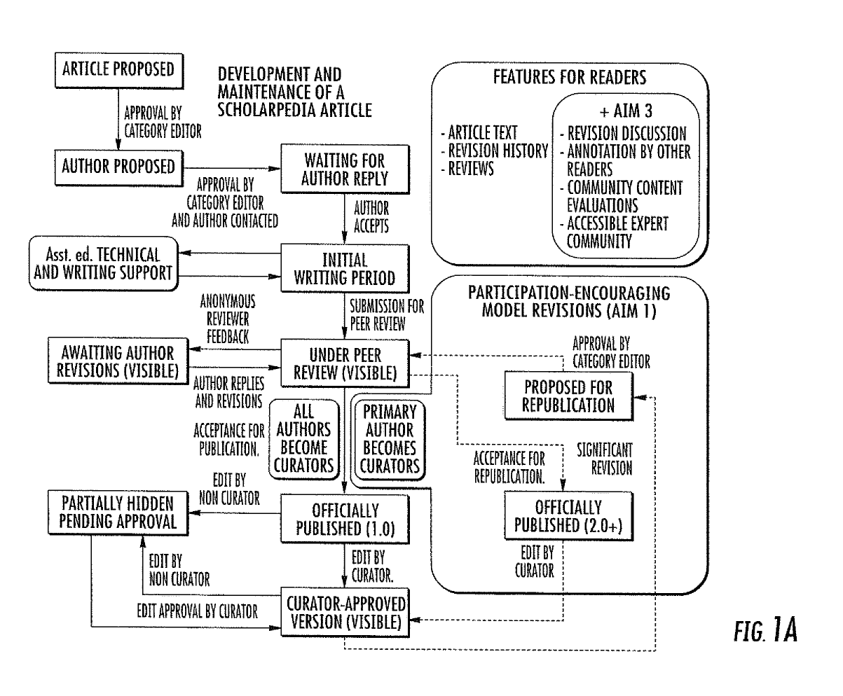

Referring now to FIG. 1, one embodiment of a generalized method of creating and managing collaborative resources according to the invention is described. As shown, the method 100 comprises first providing or generating a proposal (step 102) for a collaborative work or resource. For instance, a user may wish to create a scholarly article on a given topic on which they are knowledgeable, or the proposal may be in response to a request (e.g., “call for papers” or the like), or from a particular sponsor.

Next, per step 104, a sponsor for the proposed work is identified. The sponsor may be selected by the author(s) of the proposed work, or a sponsor may volunteer to act as a sponsor unsolicited. Yet other ways of identifying sponsors will be appreciated by those of ordinary skill given the present disclosure.

Next, per step 106, the work is created by the one or more authors.

After creation, the work is reviewed so as to, inter alia, assure its quality, identify errors, check its citations, etc. per step 108 As described in greater detail below, the review may be conducted by the sponsor(s), or yet others.

Finally, per step 110, the reviewed article is maintained, such as via review by any user who is granted access to it. In one embodiment, this review process is governed by a “curator” of the work, although other models may be used consistent with the invention.

FIG. 1A illustrates one exemplary implementation of the method 100 of FIG. 1.

### Exemplary Implementation—“Curatorpedia”:

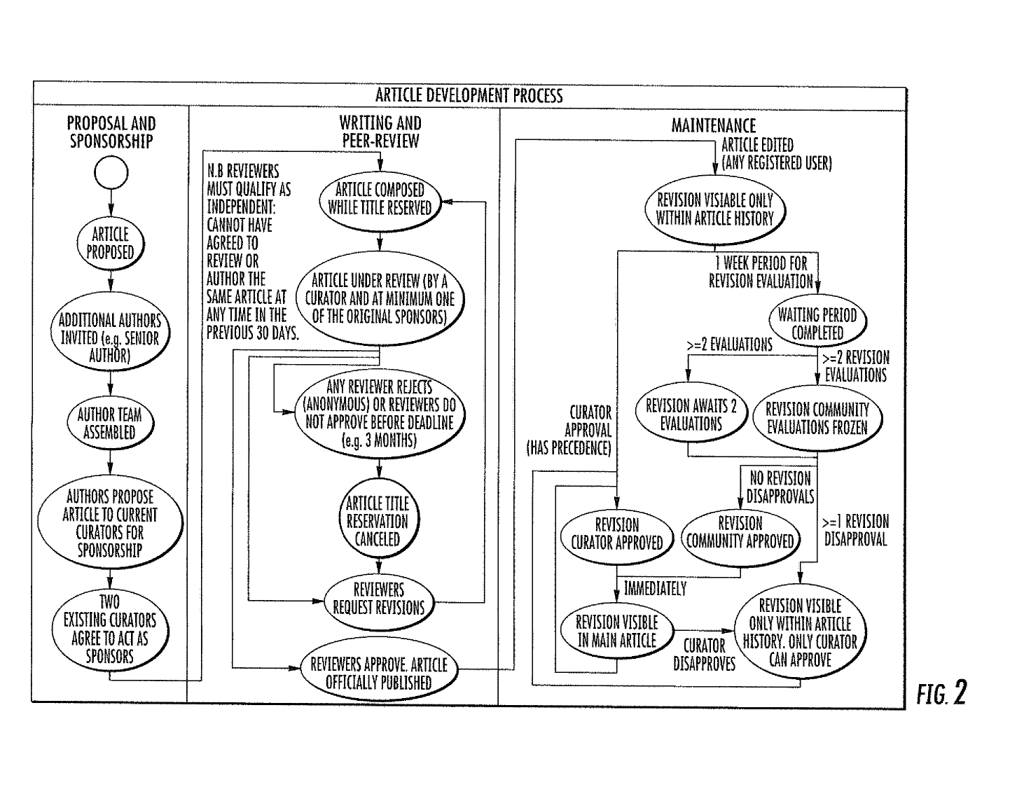

Referring now to FIG. 2, one exemplary implementation of the invention (and generalized methodology of FIG. 1) is described. This particular implementation is colloquially referred to herein as “Curatorpedia”, although it will be appreciated that this nomenclature is purely arbitrary, and in no way connotes or confers and limitations on the broader implementations of the invention.

In the exemplary implementation of Curatorpedia, there is a set of experts—curators—who maintain the quality of the project. Each collaborative resource (e.g., article) is authored by a highly capable individual (e.g. an expert in their field) who is sponsored by e.g., two existing curators. Each article is peer-reviewed and validated by at least two independent curators.

Upon validation, the most senior expert author of the article becomes its curator (and he/she joins the group of Curatorpedia curators, so that he can sponsor and review other articles). The reviewers, and more junior authors of the article become its assistant curators.

Any registered user can modify and improve the article. However, the modification needs to be approved by one or more assistant curators before it appears in the final approved version, and is shown to the public. Upon approval, the registered user submitting the modification joins the team of assistant curators of the article, and he/she can participate in the approval of revisions of this article submitted by other users.

Users are assigned a “curator rank” that reflects their contribution to the project, and endows them with certain privileges.

When an article curator resigns or is no longer available, a team of assistant curators elects a desirable entity (e.g., top expert) to become the curator for that resource. Their votes are in one variant weighted by their curator ranks (i.e., the vote of the most capable or “senior” assistant (as determined by his/her curator rank) is given the most weight).

### Author Selection of Reviewers

Scholarly articles gain their legitimacy largely due to the process of “scholarly peer review” (SPP). The peer review process ensures that only original and well-performed research is approved for publication. To allow reviewers to speak candidly about the articles they review, the identity of reviewers is typically kept anonymous. When review is non-anonymous, conflicts of interest can arise, for instance when a reviewer may fear reprisal for a review that is highly critical.

The review process is generally mediated by an Editor employed by a journal—the editor, who is usually an academic, uses his or her expertise to select reviewers capable of evaluating the article. The editor also facilitates anonymous communication between the reviewers and the article's authors. Because the reviewer is typically not anonymous to the editor, reviewers are prevented from being too negative or biased.

In contrast, the exemplary embodiment of the invention described here employs a unique mechanism that provides the same benefits of supervised peer review, but in a way that does not require a dedicated pre-assigned editor. Rather than have reviewers selected by an editor, the authors of the article themselves choose either (a) an editor, or (b) the individuals whom they would like to act as reviewers. The invention addresses the major biases that this approach could introduce: (i) that reviewers may be afraid of reprisals if they reject an article; (ii) that authors are likely to choose reviewers or and editor who would be sympathetic to the authors' position; and (iii) that an editor might not select individuals sufficiently qualified to review. These potential biases are addressed in a variety of ways. Specifically, in the exemplary implementation:
Authors invite a single action editor or two or more reviewers from among the list of Scholarpedia/Curatorpedia curators. These individuals are already recognized as experts, thus eliminating the possibility that authors would choose non-experts.
Those invited are free to decline to participate in the review for any reason—if those invited do not believe an article is very strong, but they would not like to explicitly reject the article, declining to participate provides a “plausible deniability”
The name of the action editor and every reviewer responsible for article approval appears with each article. Because reviewers are typically individuals with a high level of academic expertise and reputations to uphold, they are given incentive to reject articles that would harm the reputation of those involved in the review process.
Article rejection is done anonymously: while the exemplary implemention of the invention records who approves an article, the name of the user who rejects an article is not recorded in the Scholarpedia or Curatorpedia system.
Any person invited to a review an article is able to forward such an invitation to any other individual. If this individual is a curator, this person is free to accept or reject the article as the original invited reviewer was. If this person is not a curator, then the individual has permission to reject the article but not to accept it. This provides plausible deniability to a reviewer who knows an article to be poor but would not like to be associated with its rejection.
Public disclosure also provides a positive incentive to approve articles that are good, and to the credit of those involved.
   In particular, the exemplary embodiment of the invention implements the two forms of review (both with and without action editor involvement) in the following way:

(1) Without Action Editor

the author(s) send(s) URLs to individuals selected from a list of Curatorpedia curators in order to solicit their participation as reviewers. When a curator follows the URL, the curator is invited to sign in to Curatorpedia (if he/she has not already done so) and is taken to a page in Curatorpedia that provides the option to “approve” or “reject” the article in question.

If the curator rejects the article, the article is not approved and loses its “reserved title” status. If the curator approves/accepts the article, then if the article meets the quota for independent curator approvals, the article is published as a completed and peer-reviewed (e.g., Scholarpedia) article.

(2) With Action Editor

A second mechanism uses an “action editor” approach, requiring the participation of at least three experts. This method is preferable when the set of curators in Curatorpedia does not include someone with the expertise required to review the article.

Specifically, the author petitions individuals in Curatorpedia with curator status to act as an “action editor” of a given article. This is accomplished in one embodiment through the creation of a URL to be sent to each curator. When the URL is followed, the curator indicates whether he or she agrees to act as the article's action editor. If so, the user's status is changed in the Curatorpedia system, and the user is associated with the article.

One advantage of employing an action editor is that this individual is free to invite whomever they like to act as reviewers for the article. If the individual is not already a user of Curatorpedia, the action editor can create an account for him or her. Otherwise, the action editor selects the appropriate user from another source; e.g., the list of Scholarpedia users.

Whomever the action editor chooses to review the article in question is in one implementation displayed alongside the article during review once the article is published. Moreover, that fact that this particular editor invited the reviewers who did any such approving advantageously incentivizes the action editor (who must already be a curator) to choose demonstrably qualified individuals to act as reviewers.

### Article Sponsorship and Validation

In one embodiment, to contribute an article to Curatorpedia, a user needs to obtain sponsorship from two existing curators of Curatorpedia, whose names will appear at the bottom of the article so that their reputation validates the fact that the user is an expert in the field. The user can have other users joining him as co-authors. The sponsorship gives the user an exclusive right to the title of the article for a given period (e.g., 2 months), so that he/she can finish writing the resource, and get it peer-reviewed and accepted by one or more independent reviewers. Note that this time period may vary based on the type of collaborative resource; i.e., certain types of works may require more time to complete than others). The reviewers must be among the existing curators of Curatorpedia, preferably: (i) those who did not review each other's articles, and (ii) did not jointly reviewed another user's article within a given time period (e.g., the past month). Other criteria and permutations of the foregoing may be applied; e.g., the reviewer has not reviewed another's article in the same technical field within the past N months, etc. At least one of the reviewers should be the original sponsor. Names of reviewers are explicitly acknowledged, so their reputation validates the article content.

If the article is not accepted within the prescribed (e.g., two-month) period or if it is rejected by any of the sponsors or reviewers, the user will lose his/her exclusivity to the article title, so others can write it. The user's name appears on the article (e.g., at the top), so that his/her reputation validates the article content.

The entire process of obtaining sponsorship and/or having the article reviewed and accepted is in one exemplary implementation automated by a network server, with no necessity to have any editorial involvement or supervision. This is in contrast to all existing solicited contributions in peer-reviewed journals, which require editorial oversight.

Moreover, the present invention contemplates use of a computer-based application which facilitates creation, submission, and review/acceptance via the aforementioned networked server. For example, in one variant, the application comprises an application having a word processing, editing, and submission environment running on a portable or desktop computer that places works in the proper format for submission, checks for errors, automatically checks citations, etc. Interface with the server may be via a web portal (e.g., website with user page and login), etc.

### Article Maintenance

Upon acceptance of the article by the one or more reviewers, the author or authors become the article's “curator”, and he/she/they can then sponsor and review other articles. The sponsors and reviewers of the article become its assistant curators.

While curator, the user (author) has total control over the article content. Any registered user can modify the article. However, in the exemplary embodiment, the modification is not shown to the “public” (which may be the general public, or a subset thereof) (i) it is approved by the curator or by at least two assistant curators, and (ii) not rejected by any other assistant curator. In the case of disagreement among assistant curators, the curator's decision prevails. Users whose modifications are approved join the team of assistant curators, so that they can maintain the article for the curator. The contributions of such users are in this embodiment ranked according to one or more performance criteria; e.g., how often their judgments coincided with the curator judgments. In one variant, the criterion discussed below (see “Curator Rank”) is used to numerically quantify this performance, although it will be appreciated that other schemes may be used with equal success. Should the curator decide to resign, the highest-ranked assistant curator will be offered the curatorship of the article, or assistant curators elect a suitable person or entity (e.g., a top expert) to become the article's curator. Their votes aree in one variant weighted by their ranks.

### Curatorpedia: How to Reserve an Article

To reserve an article, a user in one embodiment of the invention accesses his/her user page, implements a function designated ‘propose article’, and provides the article's title (which may also include a short explanatory abstract or description). If such an article (or one similar) has already been proposed by another group of authors, the user will see a warning. If the article has already been accepted, the user will see an error message.

In the list of proposed articles, the user implements a function ‘obtain sponsorship URL’ and emails this URL to one or more curators of Curatorpedia to request their sponsorship. In one embodiment, this URL is kept confidential or secret, as any curator who has access to it cannot only sponsor, but also can reject the proposed article.

The names of the sponsors in one variant appear at the bottom of the author's article, so that their reputation validates the expertise of the author/proposer. If the user wants to invite co-authors, he/she implements a function ‘obtain co-authorship URL’, and emails this URL to his/her future co-authors. Again, the user maintains the URL confidential, as anybody who has access to it can join the co-author group, invite others to join, or cancel the proposed article.

When sponsors follow the sponsorship URL of an article with multiple authors, they are asked to select the senior author who will become the article's curator upon its acceptance. The other authors will become assistant curators.

### Curatorpedia: Peer-Review Process

Once a user reserves a proposed article, he/she will have a prescribed period (e.g., one month) to finish writing it, and another period (e.g., one month) to have it accepted by the reviewer(s). The acceptance deadline is in one variant displayed at the top of the article, e.g., next to the function ‘obtain reviewer URL’. It is the user's (who is the author) responsibility to email this URL to one or more other users who satisfy the following requirements of “independence”, although it will be appreciated that other criteria of independence may be used along with or in place of the following:
They must be curators of Curatorpedia
At least one of them should be the original sponsor of the proposed article.
During the past month, the curators and the user did not review
   each other's articles
   any other articles jointly.
      Again, this URL is in the present implementation kept confidential, as it provides a button to ‘accept’ or ‘reject’ the article.

The article is accepted when two independent reviewers access the reviewer URL and select the ‘accept’ function within the two-month period, and none of the original sponsors (or anybody who has access to this special URL) access the URL and select the ‘reject’ function.

The names of the reviewers in one implementation appear at the bottom of the article with the link to the revision they accepted, so that their reputation validates the content of the article.

In the case of rejection, whether explicit (e.g., a reviewer selected ‘reject’ function) or implicit (reviewers did not select ‘accept’ function during the 2-month period), the authors lose the exclusivity to the article title, and its text is moved to the senior author's user page.

### Curatorpedia: Revisions of Accepted Articles

In the exemplary embodiment, registered Curatorpedia users can revise and improve an accepted article. They can make as many or as few revisions as they wish. However, their revisions will not be visible in the main article until the revisions are approved by the community of curators and assistant curators for that particular article.

When a user finishes revising an article, he/she selects the ‘request approval’ function located, e.g., at the top of the article page. An email or other communication (e.g., text message) is sent to all assistant curators of the article with the request to approve or reject the final revision. In one embodiment, if two or more assistant curators approve the final revision (and none rejects it), the revision will be visible to the public after expiry of a given period (e.g., one week of submission for approval). If the article's curator approves it, it will be visible immediately.

Upon approval, the user who made the revision may then join the team of the article's assistant curators, so that he/she can also approve or reject revisions submitted by other users, even other assistant curators.

If the user is already an assistant curator of the article, he/she will need only one additional approval, as it is assumed that he/she approves his/her own revisions.

If the final revision is rejected by at least one assistant curator, then it awaits the final approval or rejection by the article's curator. The curator's decision is in the exemplary embodiment final, although other schemes may be used consistent with the invention.

At the top of the exemplary revision page, the server shows a link to the list of assistant curators who acted on the request for approval. If the request for approval is neither rejected nor accepted by the requisite number (e.g., two) of assistant curators, it remains in the pending form until a later revision is accepted.

### Curatorpedia: Curator Rank

In the exemplary embodiment, assistant curators are ranked according to one or more performance criteria or metrics; e.g., how often their decisions of approval or rejection of revisions coincided with the curator's decision. The assistant rank (AR) of a user is in one implementation defined as the fraction (A-D)/T, where
A is the number of user's decisions coinciding with curator's decisions (they both accepted or both rejected a revision). It also includes a user's implicit decisions; i.e., where he/she submitted their own revision for approval, and hence voted to ‘accept’ their own revision.
D is the number of user's decisions that are in disagreement with curator's decisions (the user accepted a revision but the curator rejected it, or vice versa).
T is the total number of decisions that the curator made. T may include the decisions where the user did not participate, or the implicit decisions where the curator passively agreed with the decision of other assistant curators.
   The AR of the article's curator is in this embodiment always equal to 1, and the user's AR cannot be greater than 1; it could be near zero when the user does not participate in the revision approval, and it could be negative if the user's decisions are in stark contrast with the curator's decisions.

Once the AR becomes negative, the user in the illustrated embodiment will lose his/her assistant curator privilege. They can still modify the article, but will be treated as any other user (but with a “caution” applied so as to indicate that the user is ostensibly less reliable in terms of judgment/knowlegde than others).

In one implementation, the sum of all user's assistant ranks for all the articles is used to generate his/her “curator rank” (CR). CR reflects his/her overall contribution to the project, and endows the user with certain rights and privileges. It is appreciated that other ways to calculate the AR (per article) and the combined CR may be used, and which still reflect the overall contribution and expertise of the user. For example, in one alternative, assistant curators can evaluate (vote on) revisions submitted by other users and assign a value to them; the value is weighted by the assistant curator's rank so that the vote of the best assistant curator counts the most. The averaged weighted votes obtained for revisions of a user determine his/her assistant rank.

### Other Embodiments

Aside from the exemplary Curatorpedia implementation described above, other variations and features may be used in conjunction with the invention. For example, an even stronger distinction between an article's “curator” and “author” could be very beneficial. The author would write the article, while the curator could be utilized to ensure quality (i.e., it was “good enough”). The curator might well have also been the author (as it is in Scholarpedia and Curatorpedia), but the two could be different—a curator is in one such variant effectively a “super-author”. Indeed, having a hierarchy of responsibility for every article (with the potential, of course, for equally shared credit when politically necessary) may in certain circumstances greatly facilitate article contributions.

In one embodiment, one can change the arrangement to (1) remove political incentives to share article curatorship in order to focus responsibility, and (2) have article curatorship be more like “last author status” of a academic paper, reserved in the sciences for the P.I., thereby encouraging curators to see curatorship as a “supervisory” role, in which much of the work can be done by “authors” and others. Curators would be free to assign approval rights to anyone they like, but the curator would nonetheless remain responsible for the article's content, and the person given approval rights would not automatically be given curator status.

There are multiple potential levels of participation in an article. At the top, there is article curatorship (which is a supervisory position, and does not require any actual contribution to article content, instead serving as “responsibility” for article content). Below curatorship is “authorship”, which is a status that can be bestowed by a curator, but which can also be voted-in by the relevant community, or automatically awarded based on accumulated measurements of contribution to the article. “Authorship” is mostly a status position; unless given permission by the curator, changes made by “authors” would still require approval (at least at some level). But any user could appeal to the community to be granted authorship status (and therefore, include the article on their C.V.) based on their article contributions, irrespective of the consent or participation of the curator. At least some restriction of the ability of curators to bestow this authorship status on article contributors may also be implemented if desired. The curator remains in ultimate control over what content is ultimately included in the article, but not total control over who receives credit (or how much credit).

At lower levels of article participation may exist “associate article curator” and “assistant article curator”, largely status markers for a given article, but which probably also permit some amount of added article editing privileges over a given article. These titles would be assigned automatically—so, perhaps any edit to an article by a user, if accepted, would give that user the article-specific status of “assistant curator” (and appear in a list somewhere on or “under” the article). This would probably be based on the evaluations of the contribution by the article's curator or other participants in the article's development.

There are several possible ways of providing rewards for article participation, apart from mere increases in perceived status. Other privileges may also include the ability to evaluate article contributions (e.g., edits) with a weighting that increases proportional to the rating of one's own contributions to the article. Thus, if a user Y made an edit E, existing assistant article curator X would be able to evaluate E with a weighting corresponding to X's AR (which would have to be in relation to the assistant rank of all other assistant curators of the article).

Another option to provide article editing participation incentives is to give editors with a higher AR a shorter time-window after which their edit automatically gets approved (if no response by the curator is provided). Curators, obviously, have the greatest rank, so their edits are approved instantly. Non-curators, depending on their status and the rank would in one exemplary implementation have an auto-approve time-window inversely proportional to their rank. For example, an edit by an assistant curator x would be approved in max(7,365*(1−rank(x))) days (here, rank is assumed to be bounded by 1; this is not intended to usurp the power of the curator—the curator could elect to not provide this functionality, or to suspend it when he/she was on vacation, e.g. The idea is to make the curator's job “easier”).

Alternatively (or additionally), the approval time window can be based on the collective's evaluation of the edit's worth (as calculated above). If the existing curatorship believes the edit to be highly meritorious, then the edit is automatically approved after, say, 7 to 14 days.

Still another alternative is to have the degree of merit of a revision affect how and when the curator is notified of it. Edits judged highly meritorious by an article's curator could, in their notification email, have a subject line “An edit judged ‘extremely valuable’ was just made to article XY”.

Otherwise, perhaps, curators would receive an announcement (e.g., email) at most weekly (e.g., on Monday/Tuesday mornings), which would be a digest of any edits that occurred over the past week. Ideally, the email itself would provide enough content so that the Curator would not even need to visit the article itself. E.g., the email would show the diffs, and say “this edit, judged ‘valuable’, will automatically approved in seven days”. Alternatively, the email itself might provide links or buttons that allow immediate in-email approve or rejection.

### Mobile Device—

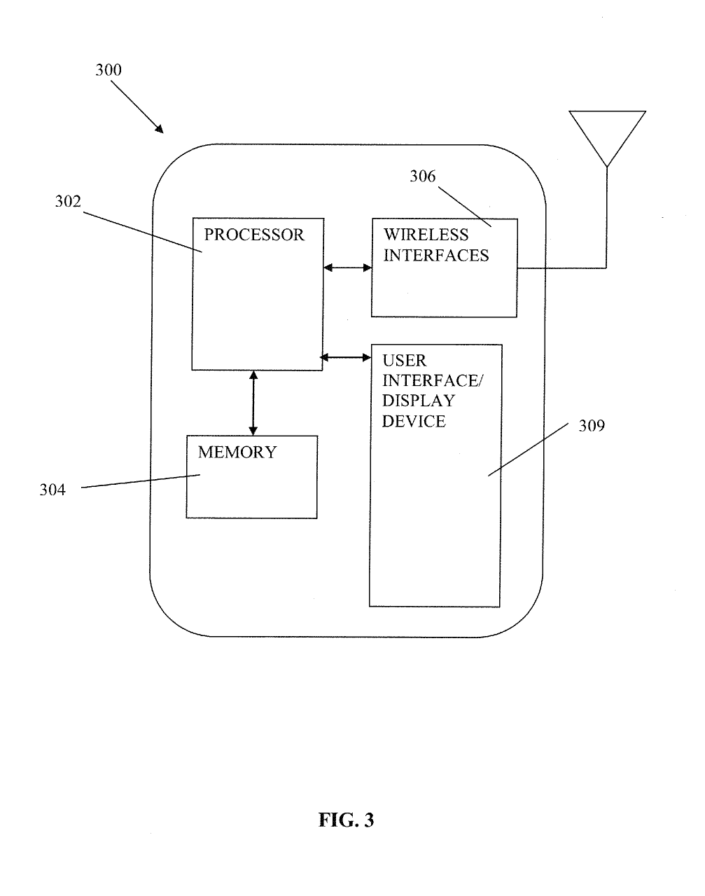

In another aspect of the invention, a mobile wireless device is disclosed. In one embodiment (FIG. 3), the device includes a processor 302, a wireless network interface 306 in data communication with the processor, a user interface 309 in data communication with the processor; a memory 304, and at least one computer disposed on the memory 304 and operative to run on the processor. In one embodiment, the at least one program is configured to, when executed: receive from at least one existing user with a curator privilege a grant of a second privilege to a user of the mobile device, the second privilege comprising the at least one existing user sponsoring the new user to write an article on a given topic. The grant may be received via email, text, or other modality. The program also is configured to allow the user to generate at least a portion of the article, and to transmit the at least portion of the article via the wireless interface 306. Once transmitted, the at least portion of the article is received by the web server, and stored as a file on a network storage apparatus. Subsequently, the user of the mobile device receives indication of validation of the article by at least one other user having the curator privilege.

In one variant, the mobile device is a smartphone or tablet computer with a touch screen display and input device, and WLAN (e.g., Wi-Fi) capability. In another variant, the mobile device is a laptop computer with keyboard and WLAN capability. The at least one computer program is rendered as an application (“app”) operative to run on the device.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed:

1. A wiki web server architecture comprising:
at least one server in operative communication with a network;
a plurality of articles disposed on a storage device associated with said server and accessible over said network;
a plurality of curators assigned to respective ones of said articles; and
a plurality of assistants assigned to said articles;
wherein each article has a curator and one or more assistants associated therewith; and
wherein modifications to each article are identified as either approved or rejected by the relevant curator or one or more assistants.

2. The architecture of claim 1, wherein a user who makes a modification to an article that is approved is permitted to join the one or more assistants associated with that article.

3. The architecture of claim 1, wherein the curator can override an approval or rejection of the one or more assistants.

4. The architecture of claim 1, wherein each of said one or more assistants has a score associated therewith, said score being based at least in part on a number of times an action of the assistant coincides with an action of the curator.

5. The architecture of claim 4, wherein the action comprises an approval or rejection.

6. The architecture of claim 4, wherein each of said one or more assistants must keep their score above a designated threshold to be eligible to perform subsequent approvals or rejections.

7. The architecture of claim 1, wherein the at least one server comprises a web server, the network comprises an internetwork, the modifications are made at least using computerized apparatus associated with respective ones of the assistants, and access to the articles is granted via a confidential uniform resource locator (URL).

8. A method of determining the content of an article accessible via the Internet using a first party and at least one second party, the method comprising:
obtaining a first review of the article from the at least one second party;
obtaining a second review of the article from the first party;
comparing the results of the first and second reviews; and
assigning a score to the at least one second party based at least in part on the act of comparing.

9. The method of claim 8, wherein:
the first review is conducted using a computerized apparatus associated with the at least one second party;
the second review is conducted using a computerized apparatus associated with the first party; and
the acts of comparing and assigning are performed using at least one computer program operative to run on a server accessible to both said at least one second party and said first party.

10. A method of determining the content of an article accessible via the Internet using a first party and a plurality of second parties, the method comprising:
obtaining a first review of the article from a first of the second parties;
obtaining a second review of the article from a second of the second parties, the second review having a result different than that of the first review;
obtaining a third review of the article from the first party;
comparing the results of the first and third and second and third reviews; and
based on said comparing, selecting either the result of the first review or the result of the second review.

11. The method of claim 10, further comprising:
assigning a first score to the second party whose review was selected; and
assigning a second score to the second party whose review was not selected.

12. A wiki web server architecture comprising:
at least one server in operative communication with a network;
a plurality of articles disposed on a storage device associated with said server and accessible over said network;
a plurality of curators; and
a plurality of assistants;
wherein each article has a curator and one or more assistants associated therewith; and
wherein modifications to each article made by the one or more assistants are approved by the relevant curator by either (i) affirmative approval; or (ii) tacit approval.

13. The architecture of claim 12, wherein said tacit approval comprises expiration of a predetermined period of time without an affirmative approval (i).

14. A computer readable storage apparatus having data stored thereon, the data comprising at least one computer readable file generated according to the method comprising:
at least one existing user with a curator privilege granting a second privilege to a new user, the second privilege comprising the at least one existing user sponsoring the new user to write an article on a given topic;
generating the article using a computerized apparatus;
storing the article in said file on the storage apparatus; and
validating the article by at least one other user having the curator privilege, the validating comprising editing at least a portion of the file.

15. The apparatus of claim 14, wherein the method further comprises granting the curator privilege to the new user after his/her activity associated with the second privilege.

16. A collaborative resource server-based method for use over a network, wherein at least one existing user with a first privilege grants a second privilege different from the first privilege to a new user.

17. The method of claim 16, wherein the network comprises the Internet, and the second privilege comprises the at least one existing user sponsoring the new user to write an article on a given topic.

18. The method of claim 17, wherein the first privilege comprises a curator privilege.

19. The method of claim 18, wherein the new user acquires the first privilege after his/her activity due to the second privilege is validated by at least one other user having the curator privilege.

20. The method of claim 16, further comprising the new user acquiring the first privilege after his/her activity due to the second privilege is validated by at least one other user having the first privilege.

21. The method of claim 16, further comprising users seeking a new privilege providing one or more universal resource locators (URLs) of said network to others of said users and requesting said others of said users to access said URLs in order to validate the new privilege.

22. A mobile wireless device, comprising:
a processor;
a wireless network interface in data communication with the processor;
a user interface in data communication with the processor; and
a computer readable storage apparatus having at least one computer disposed thereon and operative to run on the processor, the at least one program configured to, when executed:
receive from at least one existing user with a curator privilege a grant of a second privilege to a user of the mobile device, the second privilege comprising the at least one existing user sponsoring the new user to write an article on a given topic;
generate at least a portion of the article using the mobile device;
transmit the at least portion of the article via the wireless interface;
cause storage the transmitted at least portion of the article in a file on a network storage apparatus; and
receive indication of validation of the article by at least one other user having the curator privilege.
